(19) United States
(12) Patent Application Publication
(10) Pub. No.: US 2012/0107519 A1
(43) Pub. Date: May 3, 2012

(54) RADIATION CURING OF COATINGS

(75) Inventors: Huig Klinkenberg, Katwijk (NL); Marcella Gagliardo, Castricum (NL); Keimpe Jan Van Den Berg, Hudson, OH (US); Berend Mulder, Den Haag (NL); Douglas Thomas Mallin Kirk, Lundin Links (GB)

(73) Assignee: AKZO NOBEL COATINGS INTERNATIONAL B.V., ARNHEM (NL)

(21) Appl. No.: 13/259,676

(22) PCT Filed: Mar. 29, 2010
(86) PCT No.: PCT/EP2010/054057

§ 371 Date: Dec. 27, 2011

Related U.S. Application Data
(60) Provisional application No. 61/165,299, filed on Mar. 31, 2009.
(60) Provisional application No. 61/183,729, filed on Jun. 3, 2009.

(30) Foreign Application Priority Data
Mar. 31, 2009 (EP) 09156833.7
Jun. 3, 2009 (EP) 09161817.3

(51) Int. Cl. C09D 175/04; B05D 3/06; B05D 3/02; B05D 7/24

(52) U.S. Cl. 427/517; 522/174

(57) ABSTRACT

The invention relates to a process of coating a substrate with a non-aqueous coating composition comprising a) a polyol, b) a polyisocyanate crosslinker, c) a metal based catalyst for the addition reaction of hydroxyl groups and isocyanate groups, d) a thiol-functional compound at least partly deactivating the metal based catalyst, and e) a photolatent base which can be activated by actinic radiation, wherein the photolatent base prior to activation has a pKa value below 8, and wherein at least 60 mol-% of all isocyanate-reactive groups are hydroxyl groups, comprising the steps of: i) applying the coating composition to a substrate and ii) curing the coating composition.

The invention relates to a process of coating a substrate with a non-aqueous coating composition comprising a polyol binder, a polyisocyanate crosslinker, a metal based catalyst for the addition reaction of hydroxyl groups and isocyanate groups, and a thiol-functional compound. The invention further relates to the coating composition and to a kit of parts for preparing the coating composition.

A coating composition of the above-mentioned type is known from U.S. Pat. No. 4,788,083. This document describes that the metal-based catalyst is deactivated by the thiol-functional compound, which leads to a longer pot life of the composition after mixing. Activation of the coating towards curing is achieved by exposure of the applied coating to amine vapours in a curing chamber.

A drawback of the known process and composition is that curing requires curing chambers with amine vapours. Use of such curing chambers is not attractive from an economic point of view, in particular when large substrates, such as motor vehicles, need to be cured. In addition, venting of the curing chamber requires removal of the amine vapours, as these should not be released to the atmosphere for reasons of toxicity.

Curing of two-component polyol polyisocyanate coatings using a photolatent amine as catalyst is known from an article by Dietliker et al. in Farbe and Lack 109 (2003), pp. 34-41. However, the photolatent bases described in this document do not provide sufficient pot life when employed in the composition according to the present idea, nor do they provide sufficient catalytic activity after irradiation when employed in polyol-isocyanate systems.

WO2001/092362 describes coatings curing by the addition reaction of thiols and polyisocyanates, forming a polythiourethane network. Curing is activated by the release of a basic catalyst upon irradiation of a photolatent base. In one embodiment, hydroxyl groups can be present in the coating composition as well. The favourable balance of pot life and drying of the compositions described in this document results from the fast reaction of thiol groups and isocyanate groups upon activation of the photolatent base. There is a need for coating compositions and processes curing essentially by the addition reaction of hydroxyl groups and isocyanate groups, and having a similarly attractive balance of pot life and drying as the composition known from WO2001/092362.

The present invention seeks to provide a process of coating a substrate which does not have the above-mentioned drawbacks.

Accordingly, the invention provides a process of coating a substrate with a non-aqueous coating composition comprising
a) a polyol,
b) a polyisocyanate crosslinker,
c) a metal based catalyst for the addition reaction of hydroxyl groups and isocyanate groups,
d) a thiol-functional compound at least partly deactivating the metal based catalyst, and
e) a photolatent base which can be activated by actinic radiation, wherein the photolatent base prior to activation has a pKa value below 8, and wherein at least 60 mol-% of all isocyanate-reactive groups are hydroxyl groups,
comprising the steps of:
   i) applying the coating composition to a substrate and
   ii) curing the coating composition.

The coating composition used in the process of the invention has a very good balance of pot life and curing speed. Curing can be initiated by exposure to actinic radiation and there is no need for curing chambers filled with amine vapours. Furthermore, the outdoor durability of the coatings is excellent.

The invention also relates to a non-aqueous coating composition comprising
a) a polyol,
b) a polyisocyanate crosslinker,
c) a metal based catalyst for the addition reaction of hydroxyl groups and isocyanate groups,
d) a thiol-functional compound, and
e) a photolatent base which can be activated by actinic radiation, wherein the photolatent base prior to activation has a pKa value below 8,
   and wherein at least 60 mol-% of all isocyanate-reactive groups are hydroxyl groups.

Examples of suitable polyols include compounds comprising at least two hydroxyl groups. These may be monomers, oligomers, polymers, and mixtures thereof. Examples of hydroxy-functional oligomers and monomers are castor oil, trimethylol propane, and diols. Branched diols such as described in International patent application WO 98/053013, e.g. 2-butyl-ethyl-1,3-propanediol, may be mentioned in particular.

Examples of suitable polymers include polyester polyols, polyacrylate polyols, polycarbonate polyols, polyurethane polyols, melamine polyols, and mixtures and hybrids thereof. Such polymers are generally known to the skilled person and are commercially available. Suitable polyester polyols, polyacrylate polyols, and mixtures thereof are for example described in International patent application WO 96/20968 and in European patent application EP 0688840A. Examples of suitable polyurethane polyols are described in International patent application WO 96/040813.

Further examples include hydroxy-functional epoxy resins, alkyds, and dendrimeric polyols such as described in International patent application WO 93/17060. The coating composition can also comprise latent hydroxy-functional compounds such as compounds comprising bicyclic orthoester, spiro-orthoester, spiro-ortho silicate groups, or bicyclic amide acetals. These compounds and their use are described in International patent applications WO 97/31073, WO 2004/031256, and WO 2005/035613, respectively.

It has been found that using polyols having a low acid content has an additional beneficial effect for achieving a higher cure rate after irradiation. Generally, the fastest curing is obtained with polyols having the lowest acid values. Beneficial acid values are for example 10 mg KOH/g or less, or 5 mg KOH/g or less, or even less than 1 mg KOH/g, calculated on the non-volatile content of the polyol. The beneficial effect of using polyols with low acid values was also found in embodiments wherein a mercapto carboxylic acid is employed as thiol-functional compound.

Suitable isocyanate-functional crosslinkers for use in the coating composition are isocyanate-functional compounds comprising at least two isocyanate groups. Preferably, the isocyanate-functional crosslinker is a polyisocyanate, such as an aliphatic, cycloaliphatic or aromatic di-, tri- or tetra-isocyanate. Examples of diisocyanates include 1,2-propylene diisocyanate, trimethylene diisocyanate, tetramethylene diisocyanate, 2,3-butylene diisocyanate, hexamethylene diisocyanate, octamethylene diisocyanate, 2,2,4-trimethyl hexamethylene diisocyanate, dodecamethylene diisocyanate, ω,ω′-dipropylether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-vinylidene diisocyanate, dicyclohexyl methane-4,4′-diisocyanate (Desmodur® W), toluene diisocyanate, 1,3-bis(isocyanatomethyl)benzene, xylylene diisocyanate, α,α,α′,α′-tetramethyl xylylene diisocyanate (TMXDI®), 1,5-dimethyl-2,4-bis(2-isocyanatoethyl)benzene, 1,3,5-triethyl-2,4-bis(isocyanato-methyl)benzene, 4,4′-diisocyanato-diphenyl, 3,3′-dichloro-4,4′-diisocyanato-diphenyl, 3,3′-diphenyl-4,4′-diisocyanato-diphenyl, 3,3′-dimethoxy-4,4′-diisocyanato-diphenyl, 4,4′-diisocyanato-diphenyl methane, 3,3′-dimethyl-4,4′-diisocyanato-diphenylmethane, and diisocyanatonaphthalene. Examples of triisocyanates include 1,3,5-triisocyanatobenzene, 2,4,6-triisocyanatotoluene, 1,8-diisocyanato-4-(isocyanatomethyl)octane, and lysine triisocyanate. Adducts and oligomers of polyisocyanates, for instance biurets, isocyanurates, allophanates, uretdiones, urethanes, and mixtures thereof are also included. Examples of such oligomers and adducts are the adduct of 2 molecules of a diisocyanate, for example hexamethylene diisocyanate or isophorone diisocyanate, to a diol such as ethylene glycol, the adduct of 3 molecules of hexamethylene diisocyanate to 1 molecule of water (available under the trademark Desmodur N of Bayer), the adduct of 1 molecule of trimethylol propane to 3 molecules of toluene diisocyanate (available under the trademark Desmodur L of Bayer), the adduct of 1 molecule of trimethylol propane to 3 molecules of isophorone diisocyanate, the adduct of 1 molecule of pentaerythritol to 4 molecules of toluene diisocyanate, the adduct of 3 moles of m-α,α,α′,α′-tetramethyl xylene diisocyanate to 1 mole of trimethylol propane, the isocyanurate trimer of 1,6-diisocyanatohexane, the isocyanurate trimer of isophorone diisocyanate, the uretdione dimer of 1,6-diisocyanatohexane, the biuret of 1,6-diisocyanatohexane, the allophanate of 1,6-diisocyanatohexane, and mixtures thereof. Furthermore, (co)polymers of isocyanate-functional monomers such as α,α′-dimethyl-m-isopropenyl benzyl isocyanate are suitable for use.

In the coating composition according to the invention the equivalent ratio of isocyanate-functional groups to hydroxyl groups suitably is between 0.5 and 4.0, preferably between 0.7 and 3.0, and more preferably between 0.8 and 2.5. Generally, the weight ratio of hydroxy-functional binders to isocyanate-functional crosslinker in the coating composition, based on non-volatile content, is between 85:15 and 15:85, preferably between 70:30 and 30:70.

As mentioned above, at least 60 mol-% of all isocyanate-reactive groups present in the coating composition are hydroxyl groups. In other embodiments, at least 70% mol-%, or at least 80 mol-% of all isocyanate-reactive groups present in the coating composition are hydroxyl groups. Generally, a higher mol-% of hydroxyl groups on the overall number of isocyanate-reactive groups has been found to improve the outdoor durability of the cured coatings.

As mentioned above, the coating composition of the invention also comprises a metal based catalyst for the addition reaction of isocyanate groups and hydroxyl groups. Such catalysts are known to the skilled person. The catalyst is generally used in an amount of 0.001 to 10 weight-%, preferably 0.002 to 5 weight-%, more preferably in an amount of 0.01 to 1 weight-%, calculated on the non-volatile matter of the coating composition. Suitable metals in the metal based catalyst include zinc, cobalt, manganese, zirconium, bismuth, and tin. It is preferred that the coating composition comprises a tin based catalyst. Well-known examples of tin based catalysts are dimethyl tin dilaurate, dimethyl tin diversatate, dimethyl tin dioleate, dibutyl tin dilaurate, dioctyl tin dilaurate, and tin octoate.

Suitable thiol-functional compounds include dodecyl mercaptan, mercapto ethanol, 1,3-propanedithiol, 1,6-hexanedithiol, methylthioglycolate, 2-mercaptoacetic acid, mercaptosuccinic acid, and cysteine. Also suitable are esters of a thiol-functional carboxylic acid with a polyol, such as esters of 2-mercaptoacetic acid, 3-mercaptopropionic acid, 2-mercaptopropionic acid, 11-mercaptoundecanoic acid, and mercaptosuccinic acid. Examples of such esters include pentaerythritol tetrakis (3-mercaptopropionate), pentaerythritol tetrakis (2-mercaptoacetate), trimethylol propane tris (3-mercaptopropionate), trimethylol propane tris (2-mercaptopropionate), and trimethylol propane tris (2-mercaptoacetate). A further example of such a compound consists of a hyperbranched polyol core based on a starter polyol, e.g. trimethylol propane and dimethylol propionic acid, which is subsequently esterified with 3-mercaptopropionic acid and isononanoic acid. These compounds are described in European patent application EP-A-0 448 224 and International patent application WO 93/17060.

Addition products of H₂S to epoxy-functional compounds also give thiol-functional compounds. These compounds may have a structure of the following formula I[(O—CHR—CH₂—O)ₙCH₂CHXHCH₂YH]ₘ, with T being a m valent organic moiety, R being hydrogen or methyl, n being an integer between 0 and 10, X and Y being oxygen or sulfur, with the proviso that X and Y are not equal. An example of such a compound is commercially available from Cognis under the trademark Capcure® 3/800.

Other syntheses to prepare compounds comprising thiol-functional groups involve: the reaction of an aryl or alkyl halide with NaHS to introduce a pendant mercapto group into the alkyl and aryl compounds, respectively; the reaction of a Grignard reagent with sulfur to introduce a pendant mercapto group into the structure; the reaction of a polymercaptan with a polyolefin according to a nucleophilic reaction, an electrophilic reaction or a radical reaction; and the reaction of disulfides. Preferred thiol-functional compounds are pentaerythritol tetrakis(3-mercapto propionate), trimethylol propane tris(3-mercaptopropionate), and Capcure 3/800. In another embodiment of the invention the thiol groups can be covalently attached to a resin. Such resins include thiol-functional polyurethane resins, thiol-functional polyester resins, thiol-functional polyaddition polymer resins, thiol-functional polyether resins, thiol-functional polyamide resins, thiol-functional polyurea resins, and mixtures thereof. Thiol-functional resins can be prepared by the reaction of H₂₅ with an epoxy group or an unsaturated carbon-carbon bond-containing resin, the reaction between a hydroxyl-functional resin and a thiol-functional acid, and by the reaction of an isocyanate-functional polymer and either a thiol-functional alcohol or a di- or polymercapto compound.

The thiol-functional compound is generally present in an amount of 0.001 to 10 weight-%, preferably 0.002 to 5 weight-%, more preferably in an amount of 0.01 to 2 weight-%, calculated on the non-volatile matter of the coating composition. The actual amount of thiol-functional compound depends on the type and amount of metal based catalyst employed, on the thiol equivalent weight of the thiol-functional compound, and on the desired property profile of the coating composition. In some embodiments it can be beneficial to use the thiol-functional compound in such an amount that the composition comprises a molar excess of thiol groups over the metal atoms of the metal based catalyst.

The coating composition of the invention further comprises a photolatent base which can be activated by actinic radiation. Prior to activation by actinic radiation the photolatent base has a pKa value below 8.

The pKa value is the negative log of the dissociation constant K_{A} of the protonated base:

K_{A}=[HB⁺]]/[B][H⁺]

The dissociation constant is generally determined in an aqueous environment, at a temperature of 20° C.

In one embodiment, activation of the photolatent base releases a base which has a pKa value which is at least one unit higher than the pKa value prior to activation. This leads to a particularly good balance of pot life of the coating composition and curing speed upon irradiation.

Suitable photolatent bases include N-substituted 4-(o-nitrophenyl)dihydropyridines, optionally substituted with alkyl ether and/or alkyl ester groups, and quaternary organo-boron photoinitiators. An example of an N-substituted 4-(o-nitrophenyl)dihydropyridine is N-methyl nifedipine (Macromolecules 1998, 31, 4798), N-butyl nifedipine, N-butyl 2,6-dimethyl 4-(2-nitrophenyl) 1,4-dihydropyridine 3,5-dicarboxylic acid diethyl ester, and a nifedipine according to the following formula

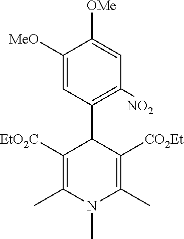

i.e. N-methyl 2,6-dimethyl 4-(4,5-dimethoxy-2-nitrophenyl) 1,4-dihydropyridine 3,5-dicarboxylic acid diethyl ester. Examples of quaternary organo-boron photoinitiators are disclosed in GB-A-2 307 473, such as

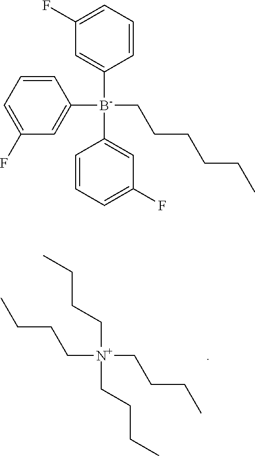

Thus far optimum results have been obtained with a photolatent base belonging to the group of α-amino acetophenones. Examples of α-amino acetophenones which can be used in the photoactivatable coating compositions according to the present invention are: 4-(methylthiobenzoyl)-1-methyl-1-morpholinoethane (Irgacure® 907 ex Ciba Specialty Chemicals) and (4-morpholinobenzoyl)-1-benzyl-1-dimethylamino propane (Irgacure® 369 ex Ciba Specialty Chemicals) disclosed in EP-A-0 898 202. Preferred is an α-amino acetophenone according to the following formula

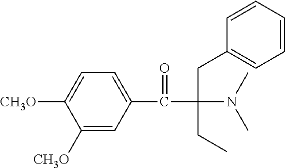

The photolatent base may be used in an amount of between 0.01 to 10 wt. % on solid curable material, preferably 0.05 to 5 wt. %, more preferably 0.05 to 3 wt. %.

The coating composition may be used and applied without a volatile diluent, in particular when low molecular weight binders, optionally in combination with one or more reactive diluents, are used. Alternatively, the coating composition may optionally comprise a volatile organic solvent. Preferably, the coating composition comprises less than 500 g/l of volatile organic solvent based on the total composition, more preferably less than 480 g/l, and most preferably 420 g/l or less. The non-volatile content of the composition, usually referred to as the solid content, preferably is higher than 50 weight-% based on the total composition, more preferably higher than 54 weight-%, and most preferably higher than 60 weight-%.

Examples of suitable volatile organic diluents are hydrocarbons, such as toluene, xylene, Solvesso 100, ketones, terpenes, such as dipentene or pine oil, halogenated hydrocarbons, such as dichloromethane, ethers, such as ethylene glycol dimethyl ether, esters, such as ethyl acetate, ethyl propionate, n-butyl acetate or ether esters, such as methoxypropyl acetate or ethoxyethyl propionate. Also mixtures of these compounds can be used.

If so desired, it is possible to include one or more so-called “exempt solvents” in the coating composition. An exempt solvent is a volatile organic compound that does not participate in an atmospheric photochemical reaction to form smog. It can be an organic solvent, but it takes so long to react with nitrogen oxides in the presence of sunlight that the Environmental Protection Agency of the United States of America considers its reactivity to be negligible. Examples of exempt solvents that are approved for use in paints and coatings include acetone, methyl acetate, parachlorobenzotrifluoride (commercially available under the name Oxsol 100), and volatile methyl siloxanes. Also tertiary butyl acetate is being considered as an exempt solvent.

In addition to the components described above, other compounds can be present in the coating composition according to the present invention. Such compounds may be binders and/or reactive diluents, optionally comprising reactive groups which may be crosslinked with the aforesaid hydroxy-functional compounds and/or isocyanate-functional crosslinkers. Examples of such other compounds are ketone resins, and latent amino-functional compounds such as oxazolidines, ketimines, aldimines, and diimines. These and other compounds are known to the skilled person and are mentioned, in al., in U.S. Pat. No. 5,214,086.

The coating composition may further comprise other ingredients, additives or auxiliaries commonly used in coating compositions, such as pigments, dyes, surfactants, pigment dispersion aids, levelling agents, wetting agents, anti-cratering agents, antifoaming agents, antisagging agents, heat stabilizers, light stabilizers, UV absorbers, antioxidants, and fillers.

As is usual with coating compositions comprising a hydroxy-functional binder and an isocyanate-functional crosslinker, the composition according to the invention has a limited pot life. Therefore, the composition is suitably provided as a multi-component composition, for example as a two-component composition or as a three-component composition. Therefore, the invention also relates to a kit of parts for preparation of the coating composition comprising
a) a binder module comprising a polyol binder and a metal based catalyst for the addition reaction of hydroxyl groups and isocyanate groups,
b) a crosslinker module comprising a polyisocyanate crosslinker, and optionally,
c) a diluent module comprising a liquid diluent,
   wherein a thiol-functional compound and a photolatent base are present, individually or in combination, in one or more of modules a) and, if present, c).

The coating composition of the invention can be applied to any substrate. The substrate may be, for example, metal, e.g., iron, steel, and aluminium, plastic, wood, glass, synthetic material, paper, leather, or another coating layer. The other coating layer can be comprised of the coating composition of the current invention or it can be a different coating composition. The coating compositions of the current invention show particular utility as clear coats, base coats, pigmented top coats, primers, and fillers. When the coating composition of the invention is a clear coat, it is preferably applied over a colour- and/or effect-imparting base coat. In that case, the clear coat forms the top layer of a multi-layer lacquer coating such as typically applied on the exterior of automobiles. The base coat may be a water borne base coat or a solvent borne base coat.

The coating compositions are suitable for coating objects such as bridges, pipelines, industrial plants or buildings, oil and gas installations, or ships. The compositions are particularly suitable for finishing and refinishing automobiles and large transportation vehicles, such as trains, trucks, buses, and airplanes.

The coating composition of the invention can likewise be used as adhesive. Therefore, the expression “coating composition” as used herein also encompasses adhesive compositions.

The coating compositions according to the invention are radiation curable. Curing of the coating can be initiated by exposing the coating composition to ultraviolet radiation prior to, during, or after application to a substrate. Exposure to ultraviolet radiation prior to application to a substrate can, for example, be carried out by exposure of the ready-to-spray coating composition to ultraviolet radiation. In one embodiment, an ultraviolet lamp may be immersed in the liquid coating composition. Alternatively, the coating composition in a container is exposed to ultraviolet radiation from an external source, such as a UV cabinet. After activation by ultraviolet light, the viscosity of the activated coating composition starts to increase. However, there is a relatively long period during which the activated coating composition can be applied, for example 1 hour, without deterioration of the final coating properties. Irradiation prior to application avoids the problems which are caused by three-dimensionally shaped substrates. A known problem with such substrates is the presence of shadow areas in UV curing processes, when radiation has to be carried out after application of the coating to a substrate. An additional advantage of irradiation prior to application is that the container with the coating composition can be irradiated safely in a closed UV light-cabinet without the risk of persons being exposed to harmful ultraviolet radiation. Even the high energy UV B or UV C radiation can be used safely.

Irradiation of the coating composition prior to application is particularly suitable for clear coat compositions.

For exposure to ultraviolet light during application use may be made of a special spray gun which allows irradiation of the spray mist with ultraviolet radiation during spraying. Suitable spray guns for such a process are described in International patent application WO 2004/69427 A. For exposure to ultraviolet radiation after application use may be made of known ultraviolet curing devices, for example hand held lamps. The exposure to ultraviolet radiation may take place directly after application, i.e. without an intermediate flash-off or evaporation phase. Alternatively, irradiation may be carried out after an intermediate flash-off or evaporation phase. It is also possible to carry out the ultraviolet radiation in more than one phase, for example
prior to and during application to a substrate,
prior to and after application to a substrate,
prior to, during, and after application to a substrate, and
during and after application to a substrate.

In all embodiments ultraviolet radiation sources which may be used are those customary for UV, such as high- and medium-pressure mercury lamps. In order to avoid any risk involved in handling UV light of very short wavelength (UV B and/or UV C light), preference is given, especially for use in automotive refinishing shops, to fluorescent lamps which produce the less injurious UV A light. UV light-emitting diodes (UV-LEDs) can likewise be used. Typical exposure times to ultraviolet radiation are 5 to 400 seconds, or 20 to 100 seconds, or 30 to 80 seconds.

After exposure to ultraviolet radiation, the coating applied to a substrate is suitably subjected to a thermal cure step wherein it is allowed to cure thermally. The thermal cure step is suitably carried out at a temperature between 10° C. and 80° C. The preferred temperature is between 20° C. and 60° C., for example 25° C., or 40° C. In one embodiment, the thermal curing step is carried out at ambient temperature without active supply of heat. Alternatively, the thermal cure step may be carried out at least partially in a heating chamber wherein heat is supplied by hot air or by convection. In a further embodiment, the thermal cure step is supported by irradiation with infrared radiation. Any commercial infrared irradiation device can be used, for example devices emitting short- or medium-wavelength infrared radiation.

It is believed that exposing the coating composition to ultraviolet radiation transforms the photolatent base to the non-latent form, i.e. an active base. It is further believed that the metal based curing catalyst which is present in the coating composition is at least partially deactivated by the thiol-functional compound, and that the deactivation is reversed in the presence of a base.

### EXAMPLES

### Abbreviations and Raw Materials Used

BYK 331 solution A mixture consisting of 10 weight-% of BYK 331, a silicone additive ex BYK Chemie, and 90 weight-% of n-butyl acetate
DBTL solution A mixture consisting of 10 weight-% of dibutyl tin dilaurate and 90 weight-% of n-butyl acetate
DOTL Dioctyl tin dilaurate
PIMP Pentaerythritol (tetrakis) 3-mercaptopropionate
2-MPA 2-Mercapto propionic acid
Tolonate HDT LV Isocyanurate trimer of hexamethylene diisocyanate ex Rhodia
Vestanat T1890 Isocyanurate trimer of isophorone diisocyanate ex Evonik
PAPO1 Polyacrylate polyol as described in Example A2 of WO 2007/020269, acid value is 12 mg KOH/g
PAPO2 Polyacrylate polyol similar to Example AB of WO 2007/020269, but without methacrylic acid and styrene, same glass transition temperature and OH value as PAPO1, acid value is 3.9 mg KOH/g
PAPO3 Similar to PAPO2, but subjected to an after treatment with the glycidyl ester of versatic acid, acid value is 0.4 mg KOH/g

### Preparation of a Polyester Polyol (PEPO)

In a reaction vessel equipped with a stirrer, a heating system, a thermocouple, a packed column, a condensor, and a water separator were placed 440 parts by weight of trimethylol propane, 170 parts by weight of hexahydrophthalic anhydride, and 390 parts by weight of Edenor V85. Furthermore, an amount of 1 weight-%, calculated on the building blocks, of 85 weight-% aqueous phosphoric acid was added as catalyst. Under inert gas the temperature was increased gradually to 240° C. The reaction water was distilled off at such a rate that the temperature at the top of the column did not exceed 102° C. The reaction was continued until a polyester having a hydroxyl value of 306 mg KOH/g was obtained. The acid value was 3 mg KOH/g.

### Comparative Coating Composition A

A clear coat composition without thiol-functional compound and without photolatent base was prepared by mixing the following components, the amounts are given in parts by weight (pbw)

| Component | pbw |
|---|---|
| PEPO | 50.27 |
| DBTL solution | 5.10 |
| BYK 331 solution | 1.00 |
| n-Butyl acetate | 13.00 |
| Tolonate HDT LV | 49.73 |
| n-Butyl acetate | 28.10 |

### Comparative Coating Composition B

A clear coat composition without photolatent base was prepared by mixing the same components as above for comparative coating composition A, and additionally 3.40 pbw of PTMP.

### Coating Composition 1 According to the Invention

A clear coat composition according to the invention was prepared by mixing the following components, the amounts are given in parts by weight (pbw)

| Component | pbw |
|---|---|
| PEPO | 50.27 |
| DBTL solution | 5.10 |
| BYK 331 solution | 1.00 |
| n-Butyl acetate | 13.00 |
| Tolonate HDT LV | 49.73 |
| n-Butyl acetate | 13.00 |
| PTMP | 3.40 |
| 2-Benzyl-1-(3,4-dimethoxy-phenyl)-2-dimethylamino-1-one (a | 1.50 |
| photolatent base) | |
| Xylene | 15.10 |

After mixing of components the clear coats A, B, and 1 were applied onto coil-coat Al panels (7×25 cm). Two layers of clear coat were sprayed with a DeVilbiss GTI 1.3 gun (pressure=2.5-2.7 bar) with 2 minutes flash-off in between.

The viscosity development of the clear coats was measured with a DIN-cup 4 (DC4) and is indicated in seconds. Light was excluded from the samples before measurement and the measurements were carried out at 22° C. The pot life is assumed to be the period of time in which the initial viscosity after mixing has doubled.

The results of the viscosity measurements are summarized in the table below.

| Time | DC4 (s) | | |
|---|---|---|---|
| (min) | A | B | 1 |
| 0 | 15.6 | 15.5 | 15.7 |
| 5 | 31.4 | 15.5 | 15.7 |
| 10 | | 15.4 | 15.5 |
| 20 | | 15.5 | 15.8 |
| 30 | | 15.6 | 15.9 |
| 60 | | 15.8 | 15.8 |
| 120 | | 16.0 | 15.7 |

From the table it can be inferred that comparative clear coat A has a very short pot life of only 5 minutes. Comparative example B, which additionally contains a thiol-functional compound, shows virtually no viscosity increase even after two hours. Likewise, the clear coat composition of Example 1 shows virtually no viscosity increase after two hours.

The touch dry times of coatings from comparative composition B and from composition 1 were determined manually under various conditions.
at room temperature (RT)
1 min irradiation with UV-A lamp followed by room temperature
1 min irradiation with UV-LED lamp followed by room temperature
continuous irradiation under UV-A lamp
in an oven at 40° C., 50° C., and 60° C.

Light intensity on the panels under UV-A lamp and UV-LED lamp (distance=48 cm from the panel; light intensity=5.6 mW/cm²) was measured with a Solameter (Digital Ultraviolet Radiometer UVA+B).

| | Drying Time to touch dry (minutes) | | | | | | |
|---|---|---|---|---|---|---|---|
| | | 1 min | 1 min | | | | |
| Formu- | | UV-A + | UV-LED + | UV-A | | | |
| lation | RT | RT | RT | (40 ° C.) | 40° C. | 50° C. | 60° C. |
| B | | | | >60 | | | |
| 1 | >>60 | 60 | 60 | 20 | >60 | >60 | 20 |

It is clear from these results that composition 1 according to the invention is activated under UV light, causing an increased drying speed at room temperature or slightly elevated temperature.

Coating compositions for Examples 2 to 4 were prepared by mixing the components summarized below. The amounts are given in parts by weight.

| Example | 2 | 3 | 4 |
|---|---|---|---|
| Binder module | | | |
| PEPO | 22.77 | 25.43 | 33.48 |
| PAPO1 | 31.55 | — | — |
| PAPO2 | — | 23.56 | — |
| PAPO3 | — | — | 23.56 |
| BYK 331 solution | 1.0 | 1.0 | 1.0 |
| 2-MPA | 0.29 | 0.29 | 0.29 |
| DOTDL | 0.6 | 0.6 | 0.6 |
| n-Butylacetate | 20.5 | 20.5 | 20.5 |
| Crosslinker module | | | |
| Tolonate HDT LV | 24.14 | 26.95 | 26.95 |
| Vestanat T 1890 | 21.54 | 24.05 | 24.05 |
| n-Butylacetate | 15 | 15 | 15 |
| Diluent module | | | |
| 2-Benzyl-1-(3,4-dimethoxy- | 0.28 | 0.28 | 0.28 |
| phenyl)-2-dimethylamino-1-one | | | |
| Xylene | 2.52 | 2.52 | 2.52 |

The viscosity of the compositions after mixing was between 15.3 and 15.8 s (DC4). The compositions of Examples 2 to 4 were spray applied as described above. Again the touch dry times were determined manually under the following conditions:
Continuous irradiation with a UV-A lamp at room temperature (UV)
1 minute irradiation with a UV-A lamp, followed by treatment in an oven at 60° C. (UV 60)
1 minute irradiation with a UV-A lamp, followed by treatment in an oven at 40° C. (UV 40)
1 minute irradiation with a UV-A lamp, followed by curing at room temperature (UV RT)

The drying times (touch dry) in minutes under the different curing conditions are summarized below

| Example | 2 | 3 | 4 |
|---|---|---|---|
| UV | 25 | 20 | 20 |
| UV 60 | 20 | 15 | 15 |
| UV 40 | 50 | 30 | 30 |
| UV RT | 125 | 90 | 80 |

From the drying times it can be inferred that the use of polyols having a low acid content has an additional beneficial effect for a achieving a high cure rate after irradiation. The fastest curing is obtained with Example 4, which is based on the polyol having the lowest acid value. All cured coatings had a very good gloss and hardness.

1) A process of coating a substrate with a non-aqueous coating composition comprising
a) a polyol,
b) a polyisocyanate crosslinker,
c) a metal based catalyst for the addition reaction of hydroxyl groups and isocyanate groups,
d) a thiol-functional compound at least partly deactivating the metal based catalyst, and
e) a photolatent base which can be activated by actinic radiation, wherein the photolatent base prior to activation has a pKa value below 8,
and wherein at least 60 mol-% of all isocyanate-reactive groups are hydroxyl groups,
the process comprising the steps of:
i) applying the coating composition to a substrate and
ii) curing the coating composition.

2) The process according to claim 1, wherein curing of the coating composition is initiated by exposing the coating composition to ultraviolet radiation prior to, during, or after application to the substrate.

3) The process according to claim 2, wherein curing of the coating composition is initiated by exposing a clear coat composition to ultraviolet radiation in a UV light cabinet prior to application to the substrate.

4) The process according to claim 2, wherein after exposure to ultraviolet radiation, the coating composition applied to the substrate is subjected to a thermal cure step wherein it is allowed to cure thermally at a temperature between 10° C. and 80° C.

5) The process according to claim 4, wherein the thermal cure step is at least partially carried out in a heating chamber wherein heat is supplied by hot air or by convection.

6) The process according to claim 4, wherein the thermal cure step is supported by irradiation with infrared radiation.

7) A non-aqueous coating composition comprising
a) a polyol,
b) a polyisocyanate crosslinker,
c) a metal based catalyst for the addition reaction of hydroxyl groups and isocyanate groups,
d) a thiol-functional compound, and
e) a photolatent base which can be activated by actinic radiation, wherein the photolatent base prior to activation has a pKa value below 8,
and wherein at least 60 mol-% of all isocyanate-reactive groups are hydroxyl groups.

8) The coating composition according to claim 7, wherein the metal of the metal based catalyst for the addition reaction of hydroxyl groups and isocyanate groups is selected from the group consisting of tin, zirconium, bismuth, and mixtures thereof.

9) The coating composition according to claim 7, wherein the amount of metal based catalyst is in the range of 0.001 to 10 weight-%, calculated on the non-volatile matter of the composition.

10) The coating composition according to claim 7, wherein the amount of thiol-functional compound is in the range of 0.001 to 10 weight-%, calculated on the non-volatile matter of the composition.

11) The coating composition according to claim 7, further comprising a volatile organic solvent.

12) The coating composition according to claim 7, wherein the acid number of the polyol does not exceed 10 mg KOH/g.

13) A kit of parts for preparation of the coating composition according to claim 7, comprising
a. a binder module comprising the polyol and the metal based catalyst for the addition reaction of hydroxyl groups and isocyanate groups,
b. a crosslinker module comprising the polyisocyanate crosslinker, and optionally,
c. a diluent module comprising a liquid diluent,
wherein the thiol-functional compound and the photolatent base are present, individually or in combination, in one or more of modules a) and c).

14)(canceled)

15) The coating composition according to claim 8, wherein the amount of metal based catalyst is in the range of 0.001 to 10 weight-%, calculated on the non-volatile matter of the composition.

16) The coating composition according to claim 9, wherein the amount of thiol-functional compound is in the range of 0.001 to 10 weight-%, calculated on the non-volatile matter of the composition.

17) The coating composition according to claim 8, further comprising a volatile organic solvent.

18) The coating composition according to claim 9, further comprising a volatile organic solvent.

19) The coating composition according to claim 10, further comprising a volatile organic solvent.

20) The coating composition according to claim 9, wherein the acid number of the polyol does not exceed 10 mg KOH/g.

21) The coating composition according to claim 10, wherein the acid number of the polyol does not exceed 10 mg KOH/g.
